(19) United States
(12) Patent Application Publication
(10) Pub. No.: US 2017/0124495 A1
(43) Pub. Date: May 4, 2017

(54) METHOD AND SYSTEM FOR MITIGATING RISK IN A SUPPLY CHAIN

(71) Applicant: Tata Consultancy Services Limited, Mumbai (IN)

(72) Inventors: Avneet SAXENA, Bangalore (IN); Rajarajan Thangavel Ramalingam, Bangalore (IN); Vandita Bansal, Bangalore (IN)

(73) Assignee: Tata Consultancy Services Limited, Mumbai (IN)

(21) Appl. No.: 15/067,940

(22) Filed: Mar. 11, 2016

(30) Foreign Application Priority Data
Nov. 4, 2015 (IN) 4197/MUM/2015

(51) Int. Cl. G06Q 10/06

(52) U.S. Cl. CPC G06Q 10/0635; G06Q 10/0637; G06Q 50/01

(57) ABSTRACT

A method and system is provided for mitigating risk in a supply chain. The present application provides a method and system for mitigating risk in a multi echelon stochastic flexible supply chain, comprises categorizing a plurality of supply chain risks pertaining into a plurality of supply chain risk sub categories; developing a risk decision model for each of the plurality of supply chain risk sub categories; extracting supply chain risk information from a plurality of information sources including a plurality of social media information sources; validating, customizing and estimating social media risk score for each of the plurality of supply chain risk sub categories; integrating estimated social media risk score for each of the plurality of supply chain risk sub categories for each supply chain member; and utilizing consolidated social media risk score in the developed risk decision model for mitigating risk.

This U.S. patent application claims priority under 35 U.S.C. §119 to Indian Patent Application No. 4197/MUM/2015, filed on Nov. 4, 2015. The entire contents of the aforementioned application are incorporated herein by reference.

### TECHNICAL FIELD

The present application generally relates to risk mitigation. Particularly, the application provides a method and system for mitigating risk in a multi echelon stochastic flexible supply chain.

### BACKGROUND

A typical supply chain may involve a plurality of organizations, human resources, activities, information, and other required resources. Thereby, making the supply chain more complex and consequently susceptible to a variety of risk. For avoiding any potential risk and maintaining a smooth operation of the supply chain, organizations develop certain risk mitigation strategies. Prior art literature illustrates various solutions for mitigating risk in multi echelon stochastic flexible supply chain.

A majority of existing solutions relies on supply chain risk decision framework, including risk modelling, mostly developed on information pertaining to said supply chain, including historic information of said supply chain. However, prior art literature has never explored utilizing supply chain risk information, particularly captured using social media information sources for mitigating risk in multi echelon stochastic flexible supply chain. Some of the prior art literature vaguely describe about utilizing social media information, however such use of social media information is confined to extraction of external risk for given supply chain. However, none of the prior art literature discloses utilizing social media information pertaining to the multi echelon stochastic flexible supply chain, wherein a variety of risks are identified, quantified and used for integrated supply chain risk modelling to minimize uncertainty and impact on the multi echelon stochastic flexible supply chain. Prior art literature is also silent on integrating information extracted from social media pertaining to said multi echelon stochastic flexible supply chain with historical information of said multi echelon stochastic flexible supply chain for various supply chain risk sub categories of different supply chain risks identified for each supply chain member of said multi echelon stochastic flexible supply.

Prior art literature have illustrated various risk models for mitigating risk in multi echelon stochastic flexible supply chain, with application of historical information pertaining to the multi echelon stochastic flexible supply chain therein, however, mitigating risk in a multi echelon stochastic flexible supply chain, while utilizing social media information sources for mitigating risk is still considered as one of the biggest challenges of the technical domain,

### OBJECTIVES OF THE INVENTION

In accordance with the present invention, the primary objective is to provide a method and system for mitigating risk in a multi echelon stochastic flexible supply chain.

Another objective of the invention is to provide a method and system for minimizing uncertainty and disruption in the multi echelon stochastic flexible supply chain and increase business continuity,

Another objective of the invention is to provide a method and system for allowing a plurality of uncertainties pertaining to the multi echelon stochastic flexible supply chain and corresponding risk reduction scenarios for mitigating risk in the multi echelon stochastic flexible supply chain.

Another objective of the invention is to provide a method and system for utilizing supply chain risk information pertaining to said multi echelon stochastic flexible supply chain extracted from a plurality of information sources including social media information sources, integrated with historical supply chain risk information pertaining to said multi echelon stochastic flexible supply chain obtained from traditional supply chain risk information sources for mitigating risk in the multi echelon stochastic flexible supply chain.

Other objects and advantages of the present invention will be more apparent from the following description when read in conjunction with the accompanying figures, which are not intended to limit the scope of the present disclosure.

### SUMMARY OF THE INVENTION

Before the present methods, systems, and hardware enablement are described, it is to be understood that this invention is not limited to the particular systems, and methodologies described, as there can be multiple possible embodiments of the present invention which are not expressly illustrated in the present disclosure. It is also to be understood that the terminology used in the description is for the purpose of describing the particular versions or embodiments only, and is not intended to limit the scope of the present invention which will be limited only by the appended claims.

The present application provides a method and system for mitigating risk in a multi echelon stochastic flexible supply chain.

The present application provides a computer implemented method for mitigating risk in a multi echelon stochastic flexible supply chain, wherein said method comprises categorizing a plurality of supply chain risks pertaining to said multi echelon stochastic flexible supply chain into a plurality of supply chain risk sub categories for each supply chain member of said multi echelon stochastic flexible supply chain; developing a risk decision model for each of the plurality of supply chain risk sub categories for each supply chain member of said multi echelon stochastic flexible supply chain; extracting supply chain risk information pertaining to said multi echelon stochastic flexible supply chain from a plurality of information sources including a plurality of social media information sources; validating, customizing and estimating social media risk score for each of the plurality of supply chain risk sub categories for each supply chain member of said multi echelon stochastic flexible supply chain using extracted supply chain risk information; integrating estimated social media risk score for each of the plurality of supply chain risk sub categories for each supply chain member of said multi echelon stochastic flexible supply chain with historical supply chain risk information pertaining to said multi echelon stochastic flexible supply chain obtained from traditional supply chain risk information sources for obtaining consolidated social media risk score for each of the plurality of supply chain risk sub categories for each supply chain member of said multi echelon stochastic flexible supply chain; and utilizing consolidated social media risk score of each of the plurality of supply chain risk sub categories for each supply chain member of said multi echelon stochastic flexible supply chain in the developed risk decision model for each of the plurality of supply chain risk sub categories for each supply chain member of said multi echelon stochastic flexible supply chain for supporting decision pertaining to said multi echelon stochastic flexible supply chain for mitigating risk.

The present application provides a system (200) for mitigating risk in a multi echelon stochastic flexible supply chain; said system (200) comprising a processor; a data bus coupled to said processor; and a computer-usable medium embodying computer code, said computer-usable medium being coupled to said data bus, said computer program code comprising instructions executable by said processor and configured for operating a supply chain categorization module (202); a risk decision model development module (204); a supply chain risk information extraction module (206); a social media risk score estimation module (208); an estimated social media risk score integration module (210); and a consolidated social media risk, score utilization module (212).

### BRIEF DESCRIPTION OF THE DRAWINGS

The foregoing summary, as well as the following detailed description of preferred embodiments, are better understood when read in conjunction with the appended drawings. For the purpose of illustrating the invention, there is shown in the drawings exemplary constructions of the invention; however, the invention is not limited to the specific methods and system disclosed. In the drawings:

FIG. 1: shows a flow chart illustrating a method for mitigating risk in a multi echelon stochastic flexible supply chain;

FIG. 2: shows a block diagram illustrating system architecture for mitigating risk in a multi echelon stochastic flexible supply chain;

FIG. 3: shows a flow chart illustrating a method for supply chain risk information extraction;

FIG. 4: shows a flow chart illustrating a framework for social handles;

FIG. 5: shows a flow chart illustrating a configuration for a multi echelon stochastic flexible supply chain; and

FIG. 6: shows a flow chart illustrating a configuration of simulation parameters and business scenarios of a multi echelon stochastic flexible supply chain.

### DETAILED DESCRIPTION OF THE INVENTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

The present application provides a computer implemented method and system for mitigating risk in a multi echelon stochastic flexible supply chain.

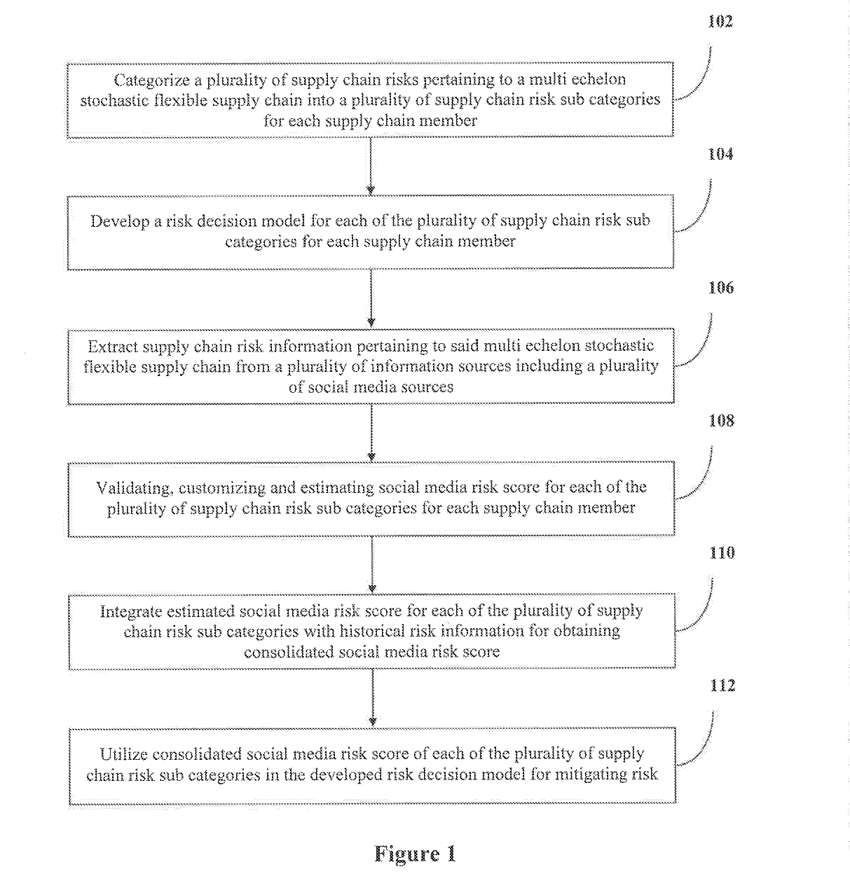

Referring to FIG. 1 is a flow chart illustrating a method for mitigating risk in a multi echelon stochastic flexible supply chain.

The process starts at step 102, a plurality of supply chain risks pertaining to a multi echelon stochastic flexible supply chain is categorized into a plurality of supply chain risk sub categories for each supply chain member of said multi echelon stochastic flexible supply chain. At the step 104, a risk decision model is developed for each of the plurality of supply chain risk sub categories for each supply chain member of said multi echelon stochastic flexible supply chain. At the step 106, supply chain risk information pertaining to said multi echelon stochastic flexible supply chain is extracted from a plurality of information sources including a plurality of social media information sources. At the step 108, social media risk score is validated, customized and estimated for each of the plurality of supply chain risk sub categories for each supply chain member of said multi echelon stochastic flexible supply chain using extracted supply chain risk information. At the step 110, estimated social media risk score for each of the plurality of supply chain risk sub categories for each supply chain member of said multi echelon stochastic flexible supply chain is integrated with historical supply chain risk information pertaining to said multi echelon stochastic flexible supply chain obtained from traditional supply chain risk information sources for obtaining consolidated social media risk score for each of the plurality of supply chain risk sub categories for each supply chain member of said multi echelon stochastic flexible supply chain. The process ends at the step 112, consolidated social media risk score of each of the plurality of supply chain risk sub categories for each supply chain member of said multi echelon stochastic flexible supply chain is utilized in the developed risk decision model for each of the plurality of supply chain risk sub categories for each supply chain member of said multi echelon stochastic flexible supply chain for supporting decision pertaining to said multi echelon stochastic flexible supply chain for mitigating risk.

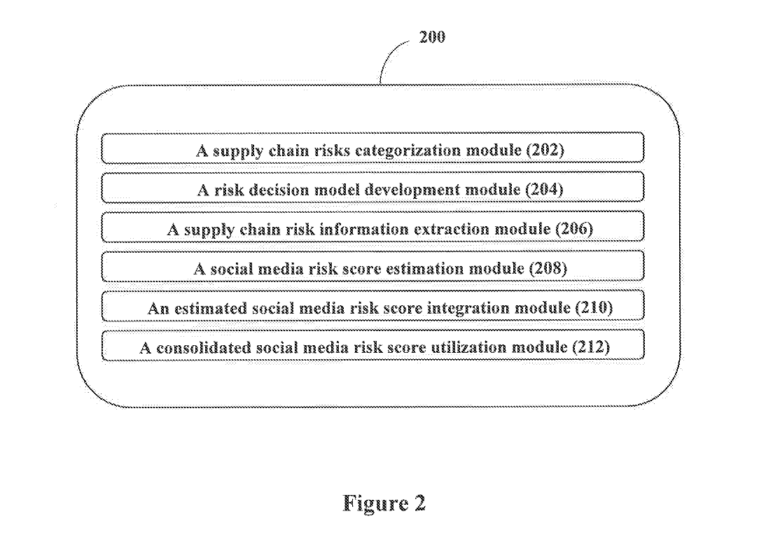

Referring to FIG. 2 is a block diagram illustrating system architecture for mitigating risk in a multi echelon stochastic flexible supply chain.

In an embodiment of the present invention, a system (200) is provided for mitigating risk in a multi echelon stochastic flexible supply chain

The system (200) for mitigating risk in a multi echelon stochastic flexible supply chain comprising a processor; a data bus coupled to said processor; and a computer-usable medium embodying computer code, said computer-usable medium being coupled to said data bus, said computer program code comprising instructions executable by said processor and configured for operating a supply chain categorization module (202); a risk decision model development module (204); a supply chain risk information extraction module (206); a social media risk score estimation module (208); an estimated social media risk score integration module (210); and a consolidated social media risk score utilization module (212).

In another embodiment of the present invention, said multi echelon stochastic flexible supply chain network and respective policies including inventory, capacity, distribution, risk categories and sub categories are configured for each supply chain member of said multi echelon stochastic flexible supply chain. The present invention also allows a plurality of uncertainties pertaining to the multi echelon stochastic flexible supply chain and corresponding risk reduction scenarios. The broad risk categories of the multi echelon stochastic flexible supply chain is selected from a group comprising but not limited to catastrophic risk (natural disaster, accidents), information risk, market risk, economic risk (financial), and operations risk (internal disruptions and external disruptions). The detailed risk categories of the multi echelon stochastic flexible supply chain is selected from a group comprising but not limited to natural disaster, accidents, financial, internal disruptions, and external disruptions. The risk sub categories of the multi echelon stochastic flexible supply chain for natural disaster is selected from a group comprising but not limited to earthquake, tsunami/floods, adverse weather; for accidents is selected from a group comprising but not limited to fire, explosions, structural failures, hazardous spills; for financial is selected from a group comprising but not limited to currency exchange rate volatility, lack of credit (cost, availability), bankruptcy; for internal disruptions outsourcer service failure, data breach, cyber-attack, unplanned IT/telecoms outage, industrial dispute, human illness, health & safety incident, product quality incident, loss of talent/skills, business ethics incident; and for external disruptions is selected from a group comprising but not limited to civil unrest/conflict, new laws or regulations, act of terrorism, energy scarcity, transport network disruption, environmental incident.

In another embodiment of the present invention, the supply chain categorization module (202) is adapted for categorizing a plurality of supply chain risks pertaining to said multi echelon stochastic flexible supply chain into a plurality of supply chain risk sub categories for each supply chain member of said multi echelon stochastic flexible supply chain. Further, the present invention extrapolates a new or existing plurality of supply chain risk sub categories of the plurality of supply chain risks for each supply chain member of said multi echelon stochastic flexible supply chain with probability of occurrence. Further, risk impact arising out of the plurality of supply chain risk sub categories of the plurality of supply chain risks for each supply chain member of said multi echelon stochastic flexible supply chain realized, controlled and mitigated.

In another embodiment of the present invention, the risk decision model development module (204) is adapted for developing a risk decision model for each of the plurality of supply chain risk sub categories for each supply chain member of said multi echelon stochastic flexible supply chain. The risk decision model for each of the plurality of supply chain risk sub categories for each supply chain member of said multi echelon stochastic flexible supply chain is developed using methods selected from a group comprising of discrete event simulation, and design of experiments approach.

In another embodiment of the present invention, the supply chain risk information extraction module (206) is adapted for extracting supply chain risk information pertaining to said multi echelon stochastic flexible supply chain from a plurality of information sources including a plurality of social media information sources. The plurality of information sources may be structured and unstructured information sources. The plurality of information sources further comprises of traditional information sources of supply chain including point of sales data for forecasting, lead time from distribution, capacity, and financial health; the plurality of social media information sources; and user added information. The social media information sources is selected from a group comprising of social media websites, blogs, Facebook, Twitter, YouTube, professional networking sites including LinkedIn, other media sources such as newspapers, magazines, and television. The extracted supply chain risk information pertaining to said multi echelon stochastic flexible supply chain from the plurality of information sources is further classified, evaluated, and analyzed for initial risk assessment of said multi echelon stochastic flexible supply chain. The supply chain risk information pertaining to said multi echelon stochastic flexible supply chain from the plurality of social media information sources is extracted using methods selected from a group comprising of machine learning algorithm, Naive Bayes Classifier (NBC), SVM, and Random Forest.

In another embodiment of the present invention, the social media risk score estimation module (208) is adapted for validating, customizing and estimating social media risk score for each of the plurality of supply chain risk sub categories for each supply chain member of said multi echelon stochastic flexible supply chain using extracted supply chain risk information. The social media risk score for each of the plurality of supply chain risk sub categories for each supply chain member of said multi echelon stochastic flexible supply chain are validated, customized and estimated using methods selected from a group comprising of statistical and heuristic.

In another embodiment of the present invention, the estimated social media risk score integration module (210) is adapted for integrating estimated social media risk score for each of the plurality of supply chain risk sub categories for each supply chain member of said multi echelon stochastic flexible supply chain with historical supply chain risk information pertaining to said multi echelon stochastic flexible supply chain obtained from traditional supply chain risk information sources for obtaining consolidated social media risk score for each of the plurality of supply chain risk sub categories for each supply chain member of said multi echelon stochastic flexible supply chain.

In another embodiment of the present invention, the consolidated social media risk score utilization module (212) is adapted for utilizing consolidated social media risk score of each of the plurality of supply chain risk sub categories for each supply chain member of said multi echelon stochastic flexible supply chain in the developed risk decision model for each of the plurality of supply chain risk sub categories for each supply chain member of said multi echelon stochastic flexible supply chain for supporting decision pertaining to said multi echelon stochastic flexible supply chain for mitigating risk.

In another embodiment of the present invention, real-time animation, summary, graphs depicting performance and report are produced for analyzing the risk impact arising out of the plurality of supply chain risk sub categories of the plurality of supply chain risks for each supply chain member of said multi echelon stochastic flexible supply chain.

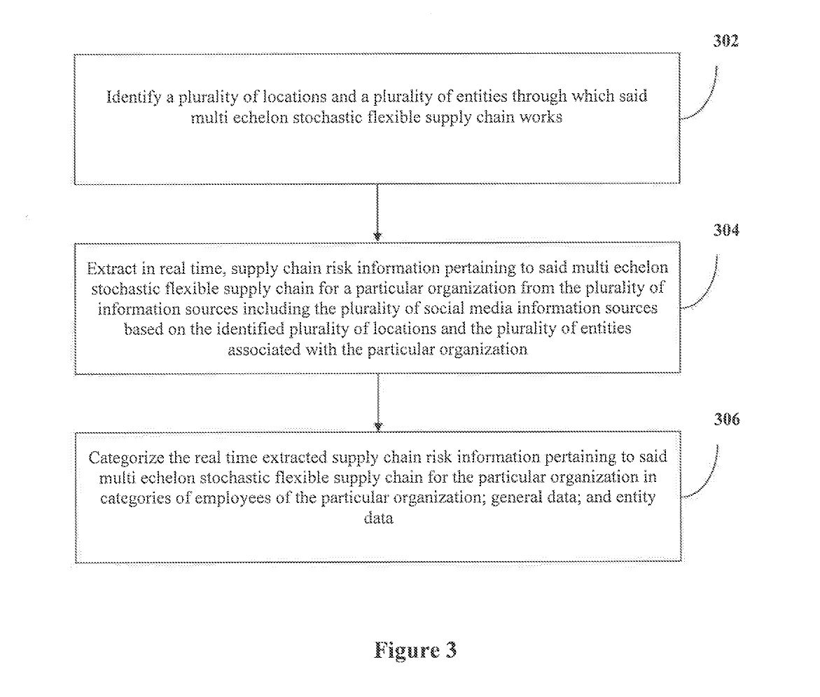

Referring to FIG. 3 is a flow chart illustrating a method for supply chain risk information extraction.

In another embodiment of the present invention, the supply chain risk information extraction module (206) is adapted for extracting supply chain risk information pertaining to said multi echelon stochastic flexible supply chain from a plurality of information sources including a plurality of social media information sources.

The process starts at step 302, a plurality of locations and a plurality of entities is identified through which said multi echelon stochastic flexible supply chain works, wherein the plurality of locations and the plurality of entities are selected from a group comprising but not limited to location of the manufacturing plants, ware houses, delivery locations, mode of transport used for delivery at various stages of said multi echelon stochastic flexible supply chain.

At the step 304, supply chain risk, information pertaining to said multi echelon stochastic flexible supply chain is extracted in real time, for a particular organization. The supply chain risk information pertaining to said multi echelon stochastic flexible supply chain for the particular organization is extracted from the plurality of information sources including the plurality of social media information sources based on the identified plurality of locations and the plurality of entities associated with the particular organization. The plurality of social media information sources are selected from a group comprising of social media websites, blogs, Facebook, Twitter, YouTube, professional networking sites including LinkedIn, other media sources such as newspapers, magazines, and television. The real time extracted supply chain risk information pertaining to said multi echelon stochastic flexible supply chain for the particular organization from the plurality of information sources including the plurality of social media information sources based on the identified plurality of locations and the plurality of entities associated with the particular organization are selected from a group comprising but not limited to different road blocks, and traffic updates.

The process ends at the step 306, the real time extracted supply chain risk information pertaining to said multi echelon stochastic flexible supply chain for the particular organization from the plurality of information sources including the plurality of social media information sources based on the identified plurality of locations and the plurality of entities associated with the particular organization is categorized; wherein the categories may comprises of data pertaining to employees of the particular organization; general data; and entity data.

The data pertaining to employees of the particular organization may be selected from a group comprising but not limited to tweets themselves, identifying social media handles by using email address of the employees of the organization, and tracking conversations of the employees of the particular organization over time with the help of the social media handles.

The data pertaining to employees of the particular organization is monitored over time. Wherein the general risk behavior of the employee may be tracked. By way of utilizing text or content posted by the individual employee, psychometric and general behavior of the employees may be tracked. If the behavior changes in terms of psychometric state or general behavior a trigger may be created which may be used in real time to find the risk in said multi echelon stochastic flexible supply chain. For example, if the number of conversations among the employees suddenly increase it may be an indicator of a collaborative activity taking place. Also, a change in the psychometric status of the individual may also be an indicator of risk to said multi echelon stochastic flexible supply chain.

The general data may be selected from a group comprising but not limited to products being sold by the particular organization, location of the warehouse, manufacturing plant, locations which are important for the particular organization's supply chain.

The general data for a particular location may be cleaned in order to obtain relevant information, wherein the relevant information may be selected from a group comprising but not limited to climatic conditions, road blocks, traffic disruptions, and natural calamity in the region. For the purpose of obtaining relevant information for the locations, a the data relevant to the location may be collected, after removing stop words, other words and the hashtags may be monitored over time. If the words associated in the posts, hashtags are indicative of such risks than the probability of risk in said multi echelon stochastic flexible supply chain may be adjusted with that factor.

The entity data may come from several entities involved therein the multi echelon stochastic flexible supply chain. The entity data for all the entities associated may be recorded, wherein the all the entities may have their own risks at various levels. If the risk associated with any particular entity increases it can increase the risk of said multi echelon stochastic flexible supply chain. The data associated with the entities involved may be collected from news forums, social media sites, blogs associated with the entities. The entity data may be cleaned to remove the stop words, punctuations, earls, and spam posts. Relevant news information, employee unrest news may be obtained and the data may be compared with the risk corpus. Based on the associations with the risk corpus the risk associated with the entities may be identified.

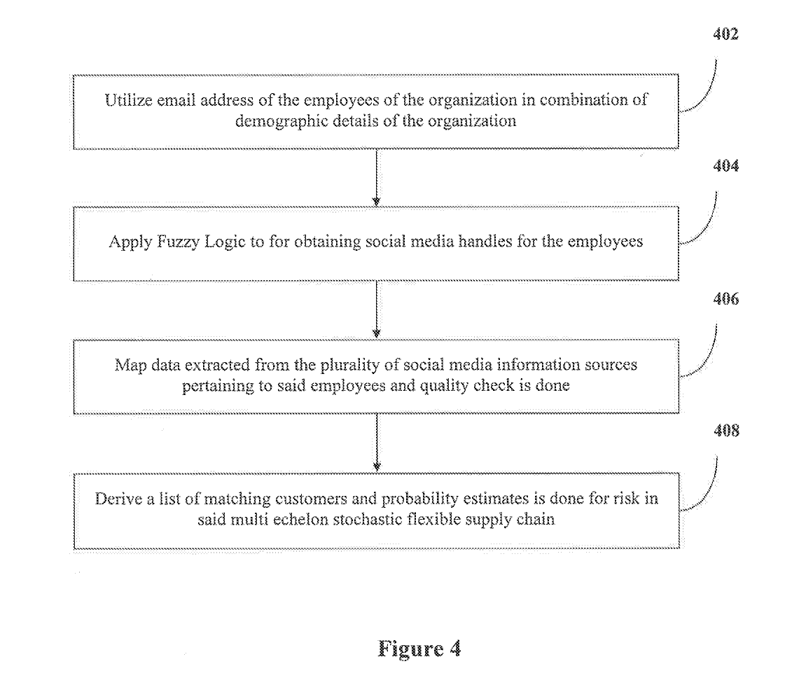

Referring to FIG. 4 is a flow chart illustrating a framework for social handles.

The process starts at step 402, email address of the employees of the organization is utilized in combination of demographic details of the organization. At the step 404, Fuzzy Logic is applied for obtaining social media handles for the employees. At the step 406, data extracted from the plurality of social media information sources pertaining to said employees is mapped and quality check is done. The process ends at the step 408, a list of matching customers is derived and probability estimates is done for risk in said multi echelon stochastic flexible supply chain.

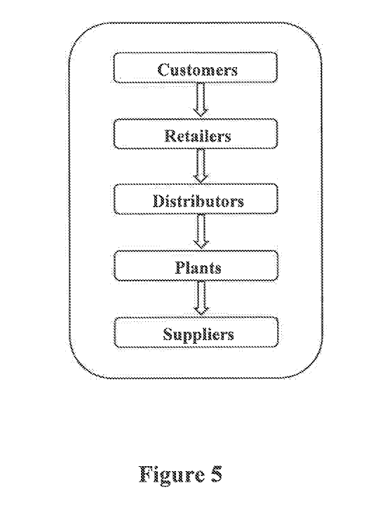

Referring to FIG. 5 is a flow chart illustrating a configuration for a multi echelon stochastic flexible supply chain.

In another embodiment of the present invention, the method and system for mitigating risk in a multi echelon stochastic flexible supply chain further comprises of configuring said multi echelon stochastic flexible supply chain. The configuration of said multi echelon stochastic flexible supply chain may be done based on parameters selected from a group comprising but not limited to information pertaining to customers, retailers, distributors, plants, suppliers, BOM components, and attributes such as simulation run time, simulation time units, number of replications.

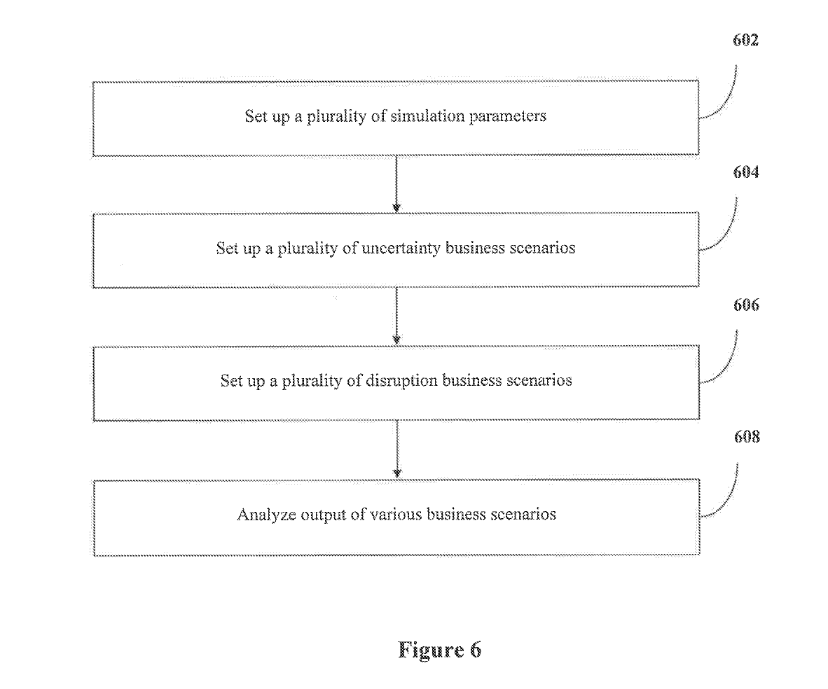

Referring to FIG. 6 is a flow chart illustrating a configuration of simulation parameters and business scenarios of a multi echelon stochastic flexible supply chain.

In another embodiment of the present invention, the method and system for mitigating risk in a multi echelon stochastic flexible supply chain further comprises of configuring simulation parameters and business scenarios pertaining to said multi echelon stochastic flexible supply chain.

The process starts at step 602, a plurality of simulation parameters are set up, wherein the plurality of simulation parameters are selected from a group comprising but not limited to flexible supply chain configuration, simulation run time, defining specific outputs, selection of model type, iterations, and setting up said multi echelon supply chain from customers to supplier based on specific industry requirement and transaction information. At the step 604, a plurality of uncertainty business scenarios are set up, wherein the uncertainty business scenarios are selected from a group comprising but not limited to defining uncertainty by setting up percentage change in demand, lead time, order time, capacity at each facility level in said multi echelon supply chain configuration. At the step 606, a plurality of disruption business scenarios are set up, wherein the disruption business scenarios are selected from a group comprising but not limited to category of disruption, number of disruption, type of disruption, partial and full impact in percentage, recovery period, at overall and individual facility levels. The process ends at the step 608, a business scenarios output is analyzed, wherein the business scenarios output analysis is selected from a group comprising but not limited to real simulation runs analysis of each supply chain member of said multi echelon supply chain, detail analysis of said multi echelon supply chain, impact of risk in said multi echelon supply chain and each supply chain member of said multi echelon supply chain, comparison of various scenarios to mitigate supply chain risk under given operational condition, generate various reports, graphs and executive summary for each scenario.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for mitigating risk in a multi echelon stochastic flexible supply chain; said method comprising processor implemented steps of:
a. categorizing a plurality of supply chain risks pertaining to said multi echelon stochastic flexible supply chain into a plurality of supply chain risk sub categories for each supply chain member of said multi echelon stochastic flexible supply chain using a supply chain categorization module (202);
b. developing a risk decision model for each of the plurality of supply chain risk sub categories for each supply chain member of said multi echelon stochastic flexible supply chain using a risk decision model development module (204);
c. extracting supply chain risk information pertaining to said multi echelon stochastic flexible supply chain from a plurality of information sources including a plurality of social media information sources using a supply chain risk information extraction module (206);
d. validating, customizing and estimating social media risk score for each of the plurality of supply chain risk sub categories for each supply chain member of said multi echelon stochastic flexible supply chain using extracted supply chain risk information using a social media risk score estimation module (208);
e. integrating estimated social media risk score for each of the plurality of supply chain risk sub categories for each supply chain member of said multi echelon stochastic flexible supply chain with historical supply chain risk information pertaining to said multi echelon stochastic flexible supply chain obtained from traditional supply chain risk information sources for obtaining consolidated social media risk score for each of the plurality of supply chain risk sub categories for each supply chain member of said multi echelon stochastic flexible supply chain using an estimated social media risk score integration module (210); and
f. utilizing consolidated social media risk score of each of the plurality of supply chain risk sub categories for each supply chain member of said multi echelon stochastic flexible supply chain in the developed risk decision model for each of the plurality of supply chain risk sub categories for each supply chain member of said multi echelon stochastic flexible supply chain for supporting decision pertaining to said multi echelon stochastic flexible supply chain for mitigating risk using a consolidated social media risk score utilization module (212).

2. The method as claimed in claim 1, wherein the risk categories of the multi echelon stochastic flexible supply chain is selected from a group comprising of catastrophic risk, information risk, market risk, economic risk, and operations risk and the risk sub categories of the multi echelon stochastic flexible supply chain is selected from a group comprising of earthquake, tsunami, floods, adverse weather, fire, explosions, structural failures, hazardous spills, currency exchange rate volatility, lack of credit, bankruptcy, outsourcer service failure, data breach, cyber-attack, unplanned information technology, telecoms outage, industrial dispute, human illness, health & safety incident, product quality incident, loss of talent and skills, business ethics incident, civil unrest and conflict, new laws or regulations, act of terrorism, energy scarcity, transport network disruption, and environmental incident.

3. The method as claimed in claim 1, further comprises of configuring said multi echelon stochastic flexible supply chain network and respective policies including inventory, capacity, distribution, risk categories and sub categories for each supply chain member of said multi echelon stochastic flexible supply chain.

4. The method as claimed in claim 1, further comprises of extrapolating a new or existing plurality of supply chain risk sub categories of the plurality of supply chain risks for each supply chain member of said multi echelon stochastic flexible supply chain with probability of occurrence.

5. The method as claimed in claim 1, wherein the supply chain risk information extraction pertaining to said multi echelon stochastic flexible supply chain from the plurality of information sources is comprising processor implemented steps of:
a. identifying a plurality of locations and a plurality of entities pertaining to said multi echelon stochastic flexible supply chain;
b. extracting in real time supply chain risk information pertaining to said multi echelon stochastic flexible supply chain for a particular organization based on the identified plurality of locations and the plurality of entities associated with the particular organization; and
c. the real time extracted supply chain risk information pertaining to said multi echelon stochastic flexible supply chain for the particular organization is categorized.

6. The method as claimed in claim 5, wherein the plurality of locations and the plurality of entities are selected from a group comprising but not limited to location of the manufacturing plants, ware houses, delivery locations, mode of transport used for delivery at various stages of said multi echelon stochastic flexible supply chain.

7. The method as claimed in claim 5, wherein the real time extracted supply chain risk information pertaining to said multi echelon stochastic flexible supply chain for the particular organization is categorized in data pertaining to employees of the particular organization; general data; and entity data.

8. The method as claimed in claim 7, wherein the data pertaining to employees of the particular organization is comprising processor implemented steps of:
a. utilizing email address of the employees of the organization in combination of demographic details of the organization;
b. applying fuzzy logic for obtaining social media handles for the employees;
c. mapping data extracted from the plurality of social media information sources pertaining to said employees and checking quality of the data; and
d. deriving a list of matching customers and estimating risk probability in said multi echelon stochastic flexible supply chain.

9. The method as claimed in claim 7, wherein the data pertaining to employees of the particular organization is utilized to track psychometric and general risk behavior of the employee.

10. The method as claimed in claim 7, wherein the categorized general data of the real time extracted supply chain risk information is selected from a group comprising of products being sold by the particular organization, location of the warehouse, manufacturing plant, locations which are important for the particular organization's supply chain.

11. The method as claimed in claim 1, wherein the extracted supply chain risk information pertaining to said multi echelon stochastic flexible supply chain from the plurality of information sources is further classified, evaluated, and analyzed for initial risk assessment of said multi echelon stochastic flexible supply chain.

12. The method as claimed in claim 1, further comprises of realizing, controlling and mitigating risk impact arising out of the plurality of supply chain risk sub categories of the plurality of supply chain risks for each supply chain member of said multi echelon stochastic flexible supply chain.

13. The method as claimed in claim 1, further comprises of outputting real-time animation, summary, graphs depicting performance and report for analyzing the risk impact arising out of the plurality of supply chain risk sub categories of the plurality of supply chain risks for each supply chain member of said multi echelon stochastic flexible supply chain.

14. The method as claimed in claim 1, wherein the plurality of information sources further comprises of traditional information sources of supply chain including point of sales data for forecasting, lead time from distribution, capacity, and financial health; the plurality of social media information sources; and user added information.

15. The method as claimed in claim 1, wherein the risk decision model for each of the plurality of supply chain risk sub categories for each supply chain member of said multi echelon stochastic flexible supply chain is developed using methods selected from a group comprising of discrete event simulation, and design of experiments approach.

16. The method as claimed in claim 1, wherein the supply chain risk information pertaining to said multi echelon stochastic flexible supply chain from the plurality of social media information sources is extracted using methods selected from a group comprising of machine learning algorithm, Naive Bayes Classifier (NBC), SVM, and Random Forest.

17. The method as claimed in claim 1, wherein the social media risk score for each of the plurality of supply chain risk sub categories for each supply chain member of said multi echelon stochastic flexible supply chain are validated, customized and estimated using methods selected from a group comprising of statistical and heuristic.

18. The method as claimed in claim 1, further comprises of allowing a plurality of uncertainties pertaining to the multi echelon stochastic flexible supply chain and corresponding risk reduction scenarios.

19. A system (200) for mitigating risk in a multi echelon stochastic flexible supply chain; said system (200) comprising:
a. a processor,
b. a data bus coupled to said processor; and
c. a computer-usable medium embodying computer code, said computer-usable medium being coupled to said data bus, said computer program code comprising instructions executable by said processor and configured for operating:
d. a supply chain categorization module (202), adapted for categorizing a plurality of supply chain risks pertaining to said multi echelon stochastic flexible supply chain into a plurality of supply chain risk sub categories for each supply chain member of said multi echelon stochastic flexible supply chain;
e. a risk decision model development module (204), adapted for developing a risk decision model for each of the plurality of supply chain risk sub categories for each supply chain member of said multi echelon stochastic flexible supply chain;
f. a supply chain risk information extraction module (206), adapted for extracting supply chain risk information pertaining to said multi echelon stochastic flexible supply chain from a plurality of social media information sources;
g. a social media risk score estimation module (208), adapted for validating, customizing and estimating social media risk score for each of the plurality of supply chain risk sub categories for each supply chain member of said multi echelon stochastic flexible supply chain using extracted supply chain risk information;
h. an estimated social media risk score integration module (210), adapted for integrating estimated social media risk score for each of the plurality of supply chain risk sub categories for each supply chain member of said multi echelon stochastic flexible supply chain with historical supply chain risk information pertaining to said multi echelon stochastic flexible supply chain obtained from traditional supply chain risk information sources for obtaining consolidated social media risk score for each of the plurality of supply chain risk sub categories for each supply chain member of said multi echelon stochastic flexible supply chain; and
i. a consolidated social media risk score utilization module (212), adapted for utilizing consolidated social media risk score of each of the plurality of supply chain risk sub categories for each supply chain member of said multi echelon stochastic flexible supply chain in the developed risk decision model for each of the plurality of supply chain risk sub categories for each supply chain member of said multi echelon stochastic flexible supply chain for supporting decision pertaining to said multi echelon stochastic flexible supply chain for mitigating risk.

20. A non-transitory computer readable medium comprising program codes executable by at least one processor for mitigating risk in a multi echelon stochastic flexible supply chain; the program codes comprising:
a. a program code for categorizing a plurality of supply chain risks pertaining to said multi echelon stochastic flexible supply chain into a plurality of supply chain risk sub categories for each supply chain member of said multi echelon stochastic flexible supply chain using a supply chain categorization module (202);
b. a program code for developing a risk decision model for each of the plurality of supply chain risk sub categories for each supply chain member of said multi echelon stochastic flexible supply chain using a risk decision model development module (204);
c. a program code for extracting supply chain risk information pertaining to said multi echelon stochastic flexible supply chain from a plurality of information sources including a plurality of social media information sources using a supply chain risk information extraction module (206);
d. a program code for validating, customizing and estimating social media risk score for each of the plurality of supply chain risk sub categories for each supply chain member of said multi echelon stochastic flexible supply chain using extracted supply chain risk information using a social media risk score estimation module (208);
e. a program code for integrating estimated social media risk score for each of the plurality of supply chain risk sub categories for each supply chain member of said multi echelon stochastic flexible supply chain with historical supply chain risk information pertaining to said multi echelon stochastic flexible supply chain obtained from traditional supply chain risk information sources for obtaining consolidated social media risk score for each of the plurality of supply chain risk sub categories for each supply chain member of said multi echelon stochastic flexible supply chain using an estimated social media risk score integration module (210); and
f. a program code for utilizing consolidated social media risk score of each of the plurality of supply chain risk sub categories for each supply chain member of said multi echelon stochastic flexible supply chain in the developed risk decision model for each of the plurality of supply chain risk sub categories for each supply chain member of said multi echelon stochastic flexible supply chain for supporting decision pertaining to said multi echelon stochastic flexible supply chain for mitigating risk using a consolidated social media risk score utilization module (212).
